(19) United States
(12) Patent Application Publication
(10) Pub. No.: US 2023/0377063 A1
(43) Pub. Date: Nov. 23, 2023

(54) AUTOMATED GASOLINE PUMP ATTACHMENT FOR COIN COUNTING AND VOUCHER DISPENSING

(71) Applicant: Diana Moon, Madison, WI (US)

(72) Inventor: Diana Moon, Madison, WI (US)

(21) Appl. No.: 18/199,039

(22) Filed: May 18, 2023

Related U.S. Application Data
(60) Provisional application No. 63/343,820, filed on May 19, 2022.

(51) Int. Cl. G06Q 50/06; B67D 7/14; G06Q 20/36; G06Q 20/14; G06Q 20/34; G07F 15/00

(52) U.S. Cl. CPC G06Q 50/06; B67D 7/145; G06Q 20/36; G06Q 20/145; G06Q 20/34; G07F 15/001

(57) ABSTRACT

A system for pumping gasoline includes a gasoline pumping assembly including a gasoline dispenser configured to perform a fueling process for a fueling process cost and a voucher assembly communicably coupled to the gasoline pumping assembly. The voucher assembly can include a coin receiver configured to receive a plurality of coins of a total value from a user and a voucher dispenser configured to provide to the user a remaining balance via a voucher when the total value is greater than the fueling process cost. The voucher can be a physical or digital voucher and can represent a value of the difference between the total value and the fueling process cost. The voucher can be redeemable for later fuel purchases or at related establishments.

### CROSS-REFERENCE TO RELATED APPLICATIONS

This application claims the benefit of and priority to U.S. Provisional Application No. 63/343,820, filed on May 19, 2022, the entire disclosure of which is hereby incorporated by reference herein.

### BACKGROUND

Payments for products and services at fuel pumps are often completed using credit cards, debit cards, checks, or cash. At the same time, most people carry some quantity of coin-based currency on their person or in their vehicle that is underutilized. Such underutilized coins inhibit the circulation of the currency and can be lost or thrown away, which over time may lead to an unnecessary increase in the amount of coin currency manufactured or lost personal wealth. A system for allowing a customer to pay for products and services at fuel pumps and related stores using coin-based currency may aid a customer in reducing spare coins and paying for such services.

### SUMMARY

One exemplary embodiment relates to a system including a gasoline pumping assembly including a gasoline dispenser configured to perform a fueling process for a fueling process cost and a voucher assembly communicably coupled to the gasoline pumping assembly. The voucher assembly includes a coin receiver configured to receive a plurality of coins of a total value from a user and a voucher dispenser configured to provide to the user a remaining balance via a voucher when the total value is greater than the fueling process cost. The remaining balance is a difference between the total value and the fueling process cost.

Another exemplary embodiment relates to a method for pumping gasoline. The method includes receiving, via a coin receiver, a plurality of coins from a user, determining a total value for the plurality of coins, initiating a fueling process from a pumping assembly, terminating the fueling process, determining whether a fueling process cost associated with the fueling process is less than the total value, and in response to a determination that the total value is greater than the fueling process cost providing, via the pumping assembly, a remaining balance on a voucher to the user, wherein the remaining balance is a difference between the total value and the fueling process cost.

Another exemplary embodiment relates to a system including a gasoline dispenser configured to perform a fueling process for a fueling process cost and a voucher assembly communicably coupled to the gasoline dispenser. The voucher assembly includes a coin receiver configured to receive a plurality of coins from a user, a voucher dispenser configured to provide to the user a voucher, and a voucher receiver configured to receive a pre-existing voucher from the user. The system further includes a database communicably coupled to the voucher assembly including a plurality of customer identifiers, and a processing circuit communicably coupled to the voucher assembly and the gasoline dispenser. The processing circuit includes one or more memory devices coupled to one or more processors, the one or more memory devices configured to store instructions thereon that, when executed by the one or more processors, cause the one or more processors to determine a total value for the plurality of coins, initiate a first fueling process for a first fueling process cost, in response to a determination that the first fueling process cost is less than the total value, provide a remaining balance to a user via a new voucher, and in response to receiving the pre-existing voucher via the voucher receiver from the user, initiating a second fueling process.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a system for providing an automated gasoline pump attachment for coin counting and voucher dispensing, according to an exemplary embodiment;

FIG. 2 is a flow diagram illustrating a process of operating a gasoline pump attachment for coin counting and voucher dispensing, according to an exemplary embodiment;

FIG. 3 is a graphical user interface shown to a user using a gasoline pump attachment for coin counting and voucher dispending, according to an exemplary embodiment; and

FIG. 4 is a graphical user interfaces shown to a user using a voucher wallet, according to one embodiment.

### DETAILED DESCRIPTION

Referring to the figures generally, the various exemplary embodiments disclosed herein relate to systems, apparatuses, and methods for the implementation and operation of an automated gasoline pump attachment for coin counting and voucher dispensing. In various embodiments, a user may deposit coins into a coin receiver at a gas pump and receive a voucher associated with the amount of currency deposited that was not expended in the gas pump transaction. In various embodiments, the voucher is operated via a voucher wallet on the user's mobile device. In some embodiments, the user may operate the gas pump with any number of payment methods, including coins, pre-existing vouchers, and standard credit or debit cards.

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### System Overview

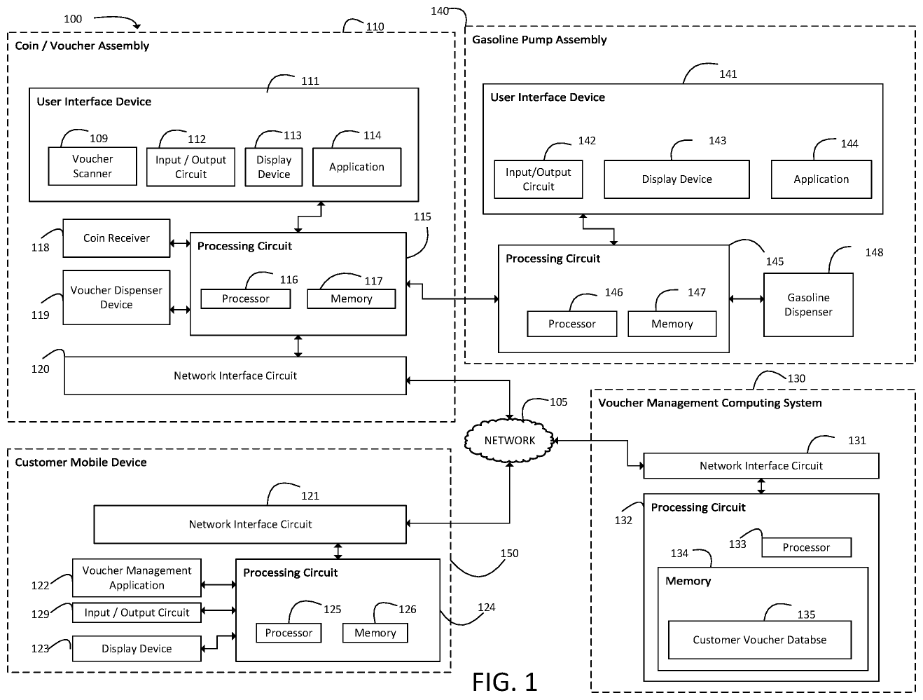

Referring now to FIG. 1, a system 100 for providing a gasoline pump attachment for coin counting and voucher dispensing is shown, according to one embodiment. The system 100 includes a customer mobile device 150, a voucher management computing system 130, a coin/voucher assembly 110, and a gasoline pump assembly 140 connected by a secure network (e.g., network 105). In operation, a user may register, via the customer mobile device 150, a voucher account with the voucher management computing system 130. Once the user has a voucher account, the user may use the customer mobile device 150 to maintain a monetary balance on the user's voucher account operated by the voucher management computing system 130. While shown as separate units, in some embodiments, the coin/voucher assembly 110 and the gasoline pump assembly 140 may be a single unitary assembly capable of performing the tasks of both the coin/voucher assembly 110 and the gasoline pump assembly 140.

### A. Coin/Voucher Assembly

The coin/voucher assembly 110 includes a device operable to receive coins from a user, dispense a voucher, exchange information with the user, dispense a voucher, and communicate with other components via the network 105 to perform the various functions provided for herein.

The coin/voucher assembly 110 includes a user interface device 111, a processing circuit 115, a coin receiver 118, a voucher dispenser device 119, and a network interface circuit 120. The user interface device 111 includes a voucher scanner 109, an input/output circuit 112, a display device 113, and an application 114. The processing circuit 115 includes a processor 116 and a memory 117. The network interface circuit 120 is used to establish connections via the network 105 between the coin/voucher assembly 110 and the voucher management computing system 130, the customer mobile device 150 and/or the gasoline pump assembly 140. The coin receiver 118 is used to receive a number of coins from a user as part of performing the various operations described herein. The number of coins can be of one or more denominations. In some embodiments, the coin receiver 118 is a hopper, bowl, or basin and can receive the number of coins (i.e., a plurality of coins) at a single time, to avoid a user having to insert coins individually. In some embodiments, the coin receiver 118 can receive the plurality of coins simultaneously and can sort the coins into one or more denominations and calculate a value of each coin and of the plurality of coins as a whole. The coin receiver 118 can therefore be used to process, sort, and determine the total value of a plurality of coins of different denominations upon only a single action by a user.

The network interface circuit 120 may include one or more antennas or transceivers and associated communications hardware and logic (e.g., computer code, instructions, etc.). The network interface circuit 120 includes program logic that is structured to allow the coin/voucher assembly 110 to access and couple/connect to the network 105 to, in turn, exchange information with, for example, the voucher management computing system 130, the gasoline pump assembly 140, and/or the customer mobile device 150. That is, the network interface 120 is coupled to the processor 116 and memory 117 and configured to enable a coupling to the network 105. The network interface 120 allows for the coin/voucher assembly 110 to transmit and receive internet data and telecommunication data. For example, the network interface circuit 120 includes any one or more of a cellular transceiver (e.g., CDMA, GSM, LTE, etc.), a wireless network transceiver (e.g., 802.11X, ZigBee, WI-FI, Internet, etc.), and/or a combination thereof (e.g., both a cellular transceiver and a wireless network transceiver). Thus, the network interface circuit 120 enables connectivity to WAN as well as LAN (e.g., Bluetooth, NFC, etc. transceivers). Alternatively, the network connection may be wired (e.g., ethernet, etc.). Further, in some embodiments, the network interface circuit 120 includes cryptography capabilities to establish a secure or relatively secure communication session between other systems such as the voucher management computing system 130, the gasoline pump assembly 140, and/or the customer mobile device 150. In this regard, information (e.g., account information, login information, financial data, custom card art, and/or other types of data) may be encrypted and transmitted to prevent or substantially prevent a threat of hacking or other security breach.

The input/output circuit 112 is structured to receive communications from and provide communications to a user of the coin/voucher assembly 110. In this regard, the input/output circuit 112 is structured to exchange data, communications, instructions, etc. with an input/output component of the coin/voucher assembly 110. The input/output circuit 112 includes hardware and associated logic (e.g., instructions, computer code, etc.) to enable the coin/voucher assembly 110 to exchange information with a user and other devices (e.g., the voucher management computing system 130) that may interact with the coin/voucher assembly 110.

The input aspect of the input/output circuit 112 and the voucher scanner 109 allows the user to input or provide information into the coin/voucher assembly 110 and may include machine-readable media for facilitating the exchange of information between the input/output device and the components of the coin/voucher assembly 110. The input/output circuit 112 and the voucher scanner 109 may include any combination of hardware components, for example, a mechanical keyboard, a touchscreen, a microphone, a camera, a fingerprint scanner, a barcode scanner, a Quick Response (“QR”) code scanner, a radio frequency identification (“RFID”) chip recognizer, and so on. The output aspect of the user input/output circuit 112 allows the user to receive information from the coin/voucher assembly 110, and may include, for example, a digital display, a speaker, illuminating icons, light emitting diodes (“LEDs”), and so on. The input/output circuit 112 may also include systems, components, devices, and apparatuses that serve both input and output functions. Such systems, components, devices and apparatuses may include, for example, radio frequency (“RF”) transceivers, near-field communication (“NFC”) transceivers, and other short range wireless transceivers (e.g., Bluetooth®, laser-based data transmitters, etc.). The input/output circuit 112 may include communication circuitry for facilitating the exchange of data, values, messages, and the like between an input/output device and the components of the coin/voucher assembly 110. Accordingly, the input/output circuit 112 may also include other hardware, software, and firmware components that may otherwise be needed for the functioning of the coin/voucher assembly 110. The voucher scanner 109 may include complementary components to the voucher dispenser device 119 such that the voucher scanner 109 can read a voucher produced by the voucher dispenser device 119.

In some embodiments, the function of the input/output circuit and/or the display device 113 may be at least partially determined by the application 114.

The display device 113 may be a screen, a touchscreen, and the like. The coin/voucher assembly 110 may use the display device 113 to communicate information to the user (e.g., by displaying the information to the user on the display device 113) and/or to receive communications from the user (e.g., through a keyboard provided on a touchscreen of the display device 113). In some embodiments, the display device 113 may be a component of the input/output circuit 112, as described above. Thus, in some embodiments, the coin/voucher assembly 110 may generate and/or receive and present various display screens (via the display device 113, for example) that include account information, transaction instructions, voucher account management options, QR codes for identifying the coin/voucher assembly 110 with a mobile device, such as the customer mobile device 150, and so on. The various display screens may be accessed via the application 114 included therein. Such display screens may be associated with a voucher management application 122 via the customer mobile device 150.

### B. Customer Mobile Device

In some embodiments, the customer mobile device 150 includes any type of mobile device operated by a user, for example in connection with financial services provided by a fuel pump services institution. As such, the customer mobile device 150 includes, but is not limited to, a phone (e.g., a smartphone), a computing device (e.g., a tablet computer, a laptop computer, a personal digital assistant, etc.), a wearable device (e.g., a smart watch, smart glasses, a smart bracelet, etc.), and so on. The customer mobile device 150 may be owned by or otherwise associated with a user. The user may be an individual, business representative, large and small business owner, and so on. The user may be an existing client or a new client to the fuel pump services institution associated with gasoline pump assembly 140.

The customer mobile device 150 includes a network interface circuit 121, a processing circuit 124, a voucher management application 122, and a display device 123. The network interface circuit 121 is used to establish connections via the network 105 between the customer mobile device 150 and the voucher management computing system 130, the coin/voucher assembly 110, and/or the gasoline pump assembly 140. The display device 123 includes an input/output circuit 129. The processing circuit 124 includes a processor 125, a memory 126, and may be communicably coupled to the voucher management application 122 and the display device 123.

In some embodiments, the network interface circuit 121 may include one or more antennas or transceivers and associated communications hardware and logic (e.g., computer code, instructions, etc.). The network interface circuit 121 includes program logic that is structured to allow the customer mobile device 150 to access and couple/connect to the network 105 to, in turn, exchange information with for example the coin/voucher assembly 110 and/or the voucher management computing system 130. That is, the network interface 121 is coupled to the processor 125 and memory 126 and configured to enable a coupling to the network 105. The network interface 120 allows for the customer mobile device 150 to transmit and receive internet data and telecommunication data. For example, the network interface circuit 121 includes any one or more of a cellular transceiver, a wireless network transceiver, and a combination thereof (e.g., both a cellular transceiver and a wireless transceiver). Thus, the network interface circuit 121 enables connectivity to WAN as well as LAN. Alternatively, the network connection may be wired (e.g., ethernet, etc.). Further, in some embodiments, the network interface circuit 121 includes cryptography capabilities to establish a secure or relatively secure communication session between other systems such as the coin/voucher assembly 110, a second mobile device, the voucher management computing system 130, and/or the gasoline pump assembly 140. In this regard, information may be encrypted and transmitted to prevent or substantially prevent a threat of hacking or other security breach.

The input/output circuit 129 is structured to receive communications from and provide communications to a user of the customer mobile device 150. In this regard, the input/output circuit 129 is structured to exchange data, communications, instructions, etc. with an input/output component of the customer mobile device 150, such as the display device 123. The input/output circuit 129 includes hardware and associated logic to enable the customer mobile device 150 to exchange information with a user and other devices (e.g., the coin/voucher assembly 110, the voucher management computing system 130, etc.) that may interact with the customer mobile device 150.

The input aspect of the input/output circuit 129 allows the user to input or provide information into the customer mobile device 150 and may include machine-readable media for facilitating the exchange of information between the input/output device and the components of the customer mobile device 150. The input/output circuit 129 may include any combination of hardware components, for example, a mechanical keyboard, a touchscreen, a microphone, a camera, a fingerprint scanner, a device engageable to the source user customer mobile device 150 via a connection, and so on. The output aspect of the user input/output circuit 129 allows the user to receive information from the customer mobile device 150, and may include, for example, a digital display, a speaker, illuminating icons, LEDs, a QR code, a barcode, an RFID chip, and so on. The input/output circuit 129 may also include systems, components, devices, and apparatuses that serve both input and output functions. Such systems, components, devices and apparatuses may include, for example, RF transceivers, NFC transceivers, and other short range wireless transceivers. The input/output circuit 129 may include communication circuitry for facilitating the exchange of data, values, messages, and the like between an input/output device and the components of the customer mobile device 150. Accordingly, the input/output circuit 129 may also include other hardware, software, and firmware components that may otherwise be needed for the functioning of the customer mobile device 150.

The display device 123 is a screen, a touchscreen, and the like. The customer mobile device 150 may use the display device 123 to communicate information to the user (e.g., by displaying the information to the user on the display device 123) and/or to receive communications from the user (e.g., through a keyboard provided on a touchscreen of the display device 123). In some embodiments, the display device 123 may be a component of the input/output circuit 129, as described above. In other embodiments, the input/output circuit 129 is included as a component of the display device 123.

In some embodiments, the customer mobile device 150 generates and/or receives and presents various display screens that include account information, transaction instructions, account management options, and so on. The various display screens may be accessed via the voucher management application 122. In some embodiments, a display screen may be used to request authentication information from the user. Authentication information may be used to unlock the mobile device, open up and use voucher management application 122, or approve a purchase with the voucher management application 122. Thus, authentication information may include, but is not limited to, a credential (e.g., username and password information for the client application), biometric information (e.g., face scan, retina scan, fingerprint, etc.) for unlocking the customer mobile device 150 and accessing the voucher management application 122, and so on. In other embodiments, a display screen may be used to present a customized visit summary relating to a user's visit to a branch location. Such display screens may be presented to the user via the display device 123.

In some embodiments, the voucher management application 122 is structured to perform a variety of functions. The voucher management application 122 is communicably coupled via the input/output circuit 129 over the network 105 to the voucher management computing system 130 for performing one or more functions described herein, including adjusting the balance on a voucher wallet. In some embodiments, the voucher management application 122 is configured to interface with the voucher management computing system 130, either directly or through the coin/voucher assembly 100 to allow a user to manage the user's voucher wallet. For example, the voucher management application 122 may facilitate the user in registering one or more vouchers. Additionally, once populated with one or more vouchers, the voucher management application 122 is further configured to facilitate and permit payments by interfacing with various fuel pumps (e.g., coin/voucher assemblies 100 and gasoline pump assemblies 140). Accordingly, in various arrangements, the voucher management application 122 is communicably coupled via the network interface circuit 120 to the voucher management computing system 130 and the coin/voucher assembly 110.

In some embodiments, the voucher management application 122 is structured to generate and present, control, and otherwise manage displays or graphical user interfaces on the customer mobile device 150. For example, the voucher management application 122 may enable the user to input information pertaining to creating and managing the user's vouchers, and transmitting the information associated with the one or more vouchers to the voucher management computing system 130. The voucher management application 122 may also be used to perform other managerial operations related to the user's voucher wallet. The voucher management application 122 may communicate with the input/output circuit 129 and/or the display device 123 to perform such tasks.

In some embodiments, and as suggested above, the voucher management application 122 is structured to provide a user with access to a variety of mobile banking and account management activities. In particular and as shown, the voucher management application 122 may be a financial institution application that may be at least partly supported by the voucher management computing system 130. Thus, the voucher management application 122 may be a financial services application, which is shown as a mobile finance application that enables a user to view, access, and manage accounts held by the provider institution (e.g., checking and/or managing one or more vouchers). The user may interact with the voucher management application 122 via the display device 123 and the input/output circuit 129. In some arrangements, the user may only access the voucher management application 122 upon providing requisite authentication information, such as username and password information, biometric information, etc. In this way, the user's access to and use of the voucher management application 122 is conditioned upon the user's authentication, which may require the user to register for an account. In some embodiments, the user may be required to create a user client application account and/or register in order to access to the voucher management application 122, which may further require the user to be user of the provider institution. Upon receiving requisite authentication information, the voucher management application 122 may be structured to initiate an authenticated session, whereupon the user may have access to the functionality of the voucher management application 122. The “authenticated session” refers to a usage session of the voucher management application 122 following authentication of the user into the voucher management application 122. The authenticated session may expire after a certain duration of time with or without action of the user related to the voucher management application 122. The voucher management application 122 may be structured to prompt the user to provide authentication information in the event the authenticated session expires.

In some embodiments, the voucher management application 122 includes a circuit embodied within the customer mobile device 150. For example, the voucher management application 122 may include program logic stored in a system memory of the customer mobile device 150. In such arrangements, the program logic may configure a processor of the customer mobile device 150 to perform at least some of the functions discussed herein with respect to a voucher management computing system 130 of the voucher management computing system 130. In some embodiments, the voucher management application 122 is a web-based application, and many of the functionalities are provided by the voucher management computing system 130. Additionally, as will be understood, the level of functionality that resides on the customer mobile device 150 versus the voucher management computing system 130 will vary depending on the implementation.

It should also be understood, however, that the role the voucher management application 122 takes in payment transactions will depend on the implementation of the voucher wallet, according to some embodiments. In some embodiments, a user can operate the coin/voucher assembly 100 and the gasoline pump assembly 140 without using the voucher management application 122. For example, a user can use at least one of the user interface 111 or the user interface 141 to provide and/or receive a voucher. The digital voucher wallets described herein are a hybrid between a secure element framework and an Host Card Emulation (“HCE”) framework. In a secure element framework, the customer mobile device 150 includes a secure element that is separate from the main system memory of the customer mobile device 150 (e.g., any element having smart card functionalities, such as a universal subscriber identity circuit (a “SIM” card) or a secure digital card). Voucher wallet data for the user is stored in the secure element on the customer mobile device 150. In an HCE framework, voucher wallet data is maintained within a cloud-based environment (e.g., a host emulation service or a customer voucher database 135 of the voucher management computing system 130). The cloud-based environment then provisions tokens or other identifiers representing vouchers the user has registered with the cloud-based environment to the voucher wallet application on the user's mobile device (e.g., the voucher management application 122 on the customer mobile device 150). The payment tokens are stored in the mobile device for a limited time until they expire, and then new payment tokens are provisioned to the mobile device.

Accordingly, the voucher wallets described herein are a hybrid between a secure element framework and an HCE framework, according to some embodiments. With the system 100, the majority of voucher wallet data is stored in remote servers (e.g., the customer voucher database 135), but a subset of the voucher wallet data may be provisioned locally to the customer mobile device 150 (e.g., in a secure element, in the memory 128, etc.). The amount of voucher wallet data stored on the remote servers versus stored on the customer mobile device 150 may depend on the level of hybridization implemented in a given voucher wallet embodiment (e.g., the extent to which the voucher wallet is implemented through a secure element framework versus the extent to which the voucher wallet is implemented through an HCE framework). Moreover, in various other arrangements, the user-specific payment information may be stored in a trusted execution environment (“TEE”) within a processor of the customer mobile device 150. The systems and methods disclosed herein may also be used with other modalities currently available for storage and transfer of user payment via contactless communication mechanisms.

In some embodiments, the voucher management application 122 is structured to enable the user to manage the voucher wallet. In this regard, the voucher management application 122 is structured to present, control, and otherwise manage displays or graphical user interfaces on the customer mobile device 150 including information related to various payment vehicles (including, but not limited, to, vouchers). For example, the voucher management application 122 may present the user with displays enabling the user to input information pertaining to various vouchers. The screens may enable the user to manually input information (e.g., a primary account number (“PAN”) for a payment vehicle) pertaining to a physical voucher or enable the user to take a picture of the physical voucher. The voucher management application 122 may then process the information input by the user, identify account information, and transmit the information to the voucher management computing system 130 for storage (e.g., in the customer voucher database 135 in association with the user).

In some embodiments, the voucher management application 122 may present the user with displays enabling the user to register non-voucher items, such as loyalty or rewards cards, coupons, gift cards, and so on, with the voucher management computing system 130. For example, to register a physical item such as a loyalty card associated with a fuel station, the voucher management application 122 may allow the user to manually input information relating to the item to be registered (e.g., a barcode number, a rewards number, etc.) and/or take a picture of the item. The voucher management application 122 may then process the input information relating to the item to be registered and transmit the information to the voucher management computing system 130 for storage (e.g., in the customer voucher database 135).

In some embodiments, the voucher management application 122 registers items to the voucher management computing system 130 without requiring input by the user. As an example, the voucher management application 122 may interface with an application running on the customer mobile device 150 (e.g., a text messaging application, an email application, an application associated with a fuel station, etc.) and extract information from the application relating to an item to be registered, such as a voucher, a coupon, a gift card, etc. The voucher management application 122 may process the extracted information relating to the item to be registered and transmit the information to the voucher management computing system 130 for storage in the customer voucher database 135. As another example, the voucher management application 122 may monitor one or more online accounts associated with the user that the user has given the voucher management application 122 permission to access, such as an email account, ticketing account, or e-commerce account whereby the user may store other vouchers for use at fuel stations. The voucher management application 122 may extract information relating to the voucher to be registered and automatically transmit the extracted information to the voucher management computing system 130.

In some embodiments, the voucher management application 122 is structured to permit the user to engage in voucher wallet transactions. As used herein, the term “voucher wallet transaction” is meant to be broadly interpreted to refer to transactions accomplished via the voucher wallet (e.g., third-party wallet, digital wallet, mobile wallet, etc.) on the customer mobile device 150 (including, but not limited to, paying for fuel at a fuel pump with the voucher wallet). In some arrangements, the voucher management application 122 engages in voucher wallet transactions through the initiation of communications with, for example, a merchant point-of-sale device. In this regard, the customer mobile device 150 may include an NFC chip and an associated controller that configures the chip to exchange information with the merchant point-of-sale device (e.g., an NFC reader on an input/output circuit 142 of a user interface device 141 of the gasoline pump assembly 140). The voucher management application 122 may thus transmit payment information to the merchant point-of-sale device using the NFC chip and associated controller. In other arrangements, the voucher management application 122 engages in voucher wallet transactions through the display device 123. For example, the customer mobile device 150 may display a QR code for a ticket on the display device 123 such that a third party can scan the QR code.

In some embodiments, the voucher management application 122 is also configured to present displays that enable the user to perform actions with digital items. As used herein, “digital items” is meant to broadly encompass items that the user has registered in the user's voucher wallet (e.g., items that the user has registered in the user's voucher wallet via the voucher management application 122). Digital items may include, for example, vouchers, digital representations of physical items (e.g., digital representations of physical vouchers, digital representations of rewards cards, loyalty cards, credit cards, coupons, and the like). In various embodiments, the voucher management application 122 presents displays enabling the user to select a payment vehicle (e.g., from the payment vehicles whose information is currently provisioned to the customer mobile device 150) for a transaction payment. Moreover, in some embodiments, the voucher management application 122 may enable the user to perform various other actions using a selected payment vehicle (e.g., use the selected vehicle to complete a voucher wallet transaction, manage a credit account at a fuel pump institution associated with the selected payment vehicle, view a transaction history associated with the voucher, and the like). Similarly, the voucher wallet application may present the user with displays that enable the user to select a registered non-payment item (e.g., from the items whose information is currently provisioned to the customer mobile device 150) and perform various actions using the selected item (e.g., show a digital representation of the item to a third party, show a barcode of the item to a third party, and the like).

### C. Voucher Management Computing System

The voucher management computing system 130 is structured to permit, enable, facilitate, manage, process, and otherwise allow voucher wallet transactions from a central location. In this regard, the voucher management computing system 130 may store information relating to various digital items, including the payment information for registered vouchers, coupons, loyalty cards, etc. The voucher management computing system 130 may be associated with, owned by, and/or otherwise operated by a voucher wallet provider. For example, a voucher wallet provide may be a financial institution associated with one or more fuel stations participating in the use of gasoline pump attachments for coin counting and voucher dispensing. While shown as a separate elements in FIG. 1, in some embodiments one or more functions of the voucher management computing system 130 can be performed boy one or more of the coin/voucher assembly 100 or the gasoline pump assembly 140.

The voucher management computing system 130 includes a network interface circuit 131 and a processing circuit 132. The network interface circuit 131 includes program logic that facilitates connection of the voucher management computing system 130 to the network 105. Accordingly, the network interface circuit 131 supports communication between the voucher management computing system 130 and other components of the system 100 via the network 105, such as between the voucher management computing system 130 and the customer mobile device 150 and the coin/voucher assembly 110.

The processing circuit 132 includes a processor 133 and a memory 134. The memory 134 includes a customer voucher database 135. The customer voucher database 135 is structured to retrievably store information regarding voucher wallet accounts held by various users, such as for a voucher wallet account held by the user of the customer mobile device 150 and other identifiers. For instance, the customer voucher database 135 may store information related to the user and/or the customer mobile device 150, such as authentication information (e.g., username/password combinations, device authentication tokens, security question answers, etc.), upon registration of one or both for a voucher wallet. The customer voucher database 135 may further store, in association with the user's voucher wallet account, the user's vouchers and digital representations of the user's vouchers. The customer voucher database 135 may store within the user's voucher wallet all or mostly all of the items that the user has registered with the voucher management computing system 130, including vouchers, loyalty cards, rewards cards, coupons, gift cards, and so on. Furthermore, the customer voucher database 135 may store any other information that may be encountered in the operation of a voucher wallet account or otherwise referenced herein, such as user preferences and other information comprising a user profile. In various embodiments, the customer voucher database 135 is structured as one or more remote data-storage facilities (e.g., cloud servers).

In some arrangements, the customer voucher database 135 also includes a token vault that is maintained by the voucher management computing system 130. The token vault may include a lookup table maintaining tokens associated with various vouchers and/or with various other payment items. The tokens stored therein may be generated internally (e.g., at the voucher management computing system 130) or by other entities (e.g., the coin/voucher assembly 110). For example, in one embodiment, the token vault may include a lookup table including tokens that have been generated and assigned to digital items such as user payment vehicles (e.g., user lines of credit, user checking accounts, and the like) and/or to third party wallets. In some arrangements, the voucher management computing system 130 may include an associated token management system (not shown) including one or more algorithms, processes, formulas, and so on that facilitate the efficient searching of the information stored in the token vault. For example, if the token is for a payment vehicle, a mapping algorithm may be utilized to map Token-to-PAN information. Thus, when a token is received, the mapping algorithm determines the associated PAN and transmits that information to the inquiring computing system.

The voucher management computing system 130 is structured to provide voucher wallet services for the user, including providing a voucher wallet on the customer mobile device 150 and allowing the user to configure a voucher wallet. In some embodiments, the voucher management computing system 130 is structured to provide a voucher wallet client application (e.g., the voucher management application 122 discussed above) on the customer mobile device 150. In this regard, the voucher management computing system 130 enables registration of a user for a voucher wallet account, presents the user with various user interfaces (including the voucher management application 122 included therein) enabling the user to use or manage the voucher wallet and enables the user to perform transactions using the voucher wallet.

In some embodiments, and as suggested above, the voucher management computing system 130 is associated with a financial institution associated with one or more fuel stations participating in the use of gasoline pump attachments for coin counting and voucher dispensing. The network interface circuit 131 is structured to establish connections/communications with the customer mobile device 150, the coin/voucher assembly 110 by way of the network 105, and the gasoline pump assembly 140 (either directly or indirectly as shown in FIG. 1). The network 105 may include one or more of the Internet, cellular network, WiFi®, Wi-Max, a proprietary banking network, or any other type of wired or wireless network or a combination of wired and wireless networks.

In some embodiments, the network interface circuit 131 includes programming and/or hardware-based components that connect the voucher management computing system 130 to the network 105. For example, the network interface circuit 131 may include any combination of a wireless network transceiver and/or wired network transceiver. In some arrangements, the network interface circuit 131 includes hardware and machine-readable media structured to support communication over multiple channels of data communication. In yet other arrangements, the network interface circuit 131 may include one or more cryptography modules to establish a secure communication session (e.g., using the IPSec protocol or similar) in which data communicated over the session is encrypted and securely transmitted.

In some embodiments, the network interface circuit 131 is connected to the processing circuit 132 in order to enable the processing circuit 132 to receiving and transmit messages, data, and information via the network 105. To further support features of or interaction with the voucher management computing system 130, the network interface circuit 131 may provide a relatively high-speed link to the network 105, which may be any combination of LAN, an intranet (e.g., a private banking or retailer network), the Internet, or any other suitable communications network, directly or through another interface.

In some embodiments, network interface circuit 131 includes program logic that may be executed by the processor 133. The memory 134 may include or be communicatively coupled to a customer voucher database 135. The memory 134 may include the customer voucher database 135.

The memory 134 includes one or more memory devices (e.g., RAM, NVRAM, ROM, Flash Memory, hard disk storage) that store data and/or computer code for facilitating the various processes described herein. That is, in operation and use, the memory 134 stores at least portions of instructions and data for execution by the processor 133 to control the processing circuit 132. The memory 134 may be or include tangible, non-transient volatile memory and/or non-volatile memory. The processor 133 may be implemented as one or more processors, application specific integrated circuits (ASIC), one or more field programmable gate arrays (FPGAs), a digital signal processor (DSP), a group of processing components, or other suitable electronic processing components. The processing circuit 132 may include one or more processors that are configured to communicate such that the processing circuit 132 may perform or assist in performing any of the operations, steps, or methods discussed herein. The customer voucher database 135 may store information regarding the accounts of one or more users, such as information relating to facilitate the operations of the voucher management computing system 130 and, by extension, the voucher management application 122 of the customer mobile device 150.

### D. Gasoline Pump Assembly

In some embodiments, the gasoline pump assembly 140 is a conventional fuel pump system used at gas station pumps. Accordingly, the coin/voucher assembly 110 may be configured to be retrofitted onto an existing gasoline pump assembly 140 to perform the various functions described herein. In other embodiments, the gasoline pump assembly may be a fuel pump system specifically configured to interface with the coin/voucher assembly 110 to perform the various functions described herein.

The gasoline pump assembly 140 includes a user interface device 141, a processing circuit 145, and a gasoline dispenser 148. The user interface device 141 may include an input/output circuit 142, a display device 143, and an application 144. The processing circuit may include a processor 146 and a memory 147.

In some embodiments, the input/output circuit 142 is structured to receive communications from and provide communications to a user of the gasoline pump assembly 140. In this regard, the input/output circuit 142 is structured to exchange data, communications, instructions, etc. with an input/output component of the gasoline pump assembly 140, such as the display device 143. The input/output circuit 142 includes hardware and associated logic (e.g., instructions, computer code, etc.) to enable the gasoline pump assembly 140 to exchange information with a user and other devices (e.g., the coin/voucher assembly 110) that may interact with the gasoline pump assembly 140.

In some embodiments, the input aspect of the input/output circuit 142 allows the user to input or provide information into the gasoline pump assembly 140 and may include machine-readable media for facilitating the exchange of information between the input/output device and the components of the gasoline pump assembly 140. The input/output circuit 142 may include any combination of hardware components, for example, a mechanical keyboard, a touchscreen, a microphone, a camera, a fingerprint scanner, a barcode scanner, a QR code scanner, an RFID reader, a device engageable to the source user gasoline pump assembly 140 via a connection (e.g., USB, serial cable, Ethernet cable, etc.), and so on. The output aspect of the user input/output circuit 142 allows the user to receive information from the gasoline pump assembly 140, and may include, for example, a digital display, a speaker, illuminating icons, light emitting diodes (“LEDs”), and so on. The input/output circuit 142 may also include systems, components, devices, and apparatuses that serve both input and output functions. Such systems, components, devices and apparatuses may include, for example, radio frequency (“RF”) transceivers, near-field communication (“NFC”) transceivers, and other short range wireless transceivers (e.g., Bluetooth®, laser-based data transmitters, etc.). The input/output circuit 142 may include communication circuitry for facilitating the exchange of data, values, messages, and the like between an input/output device and the components of the gasoline pump assembly 140. Accordingly, the input/output circuit 142 may also include other hardware, software, and firmware components that may otherwise be needed for the functioning of the gasoline pump assembly 140.

In some embodiments, the display device 143 is a screen, a touchscreen, and the like. The gasoline pump assembly 140 may use the display device 143 to communicate information to the user (e.g., by displaying the information to the user on the display device 143) and/or to receive communications from the user (e.g., through a keyboard provided on a touchscreen of the display device 143). In some embodiments, the display device 143 may be a component of the input/output circuit 142, as described above. The display device 143 may be, at least in part, operated by the application 144.

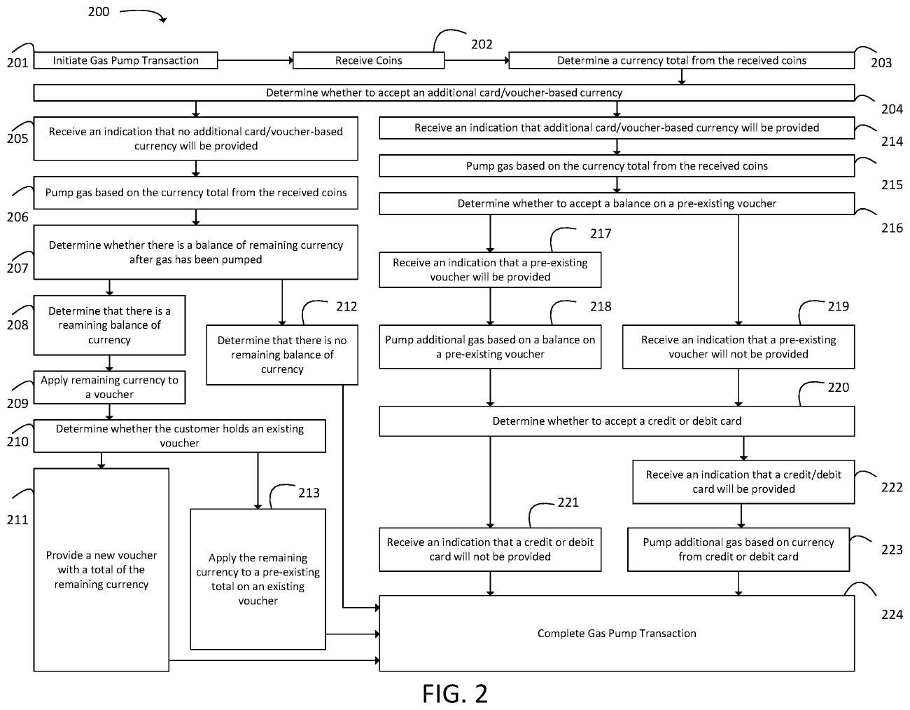

In some embodiments, the processing circuit 145 is communicably connected to the processing circuit 115 of the coin/voucher assembly 110. In this way, the gasoline pump assembly 140 may exchange information with the coin/voucher assembly 110 in order to complete gas pump transactions. For example, a user may provide partial payment for a transaction via coins or a voucher by way of the coin/voucher assembly 110 and provide the remaining payment via a credit or debit card by way of the gasoline pump assembly, as described in greater detail below in regards to FIG. 2. As suggested above, the operation of the display device 143 may be controlled by the application 144. The application 144 may in turn communicate with the application 114 of the coin/voucher assembly 110 in order to facilitate partial payments resulting in a single completed gas pump transaction.

In some embodiments, the memory 147 includes one or more memory devices (e.g., RAM, NVRAM, ROM, Flash Memory, hard disk storage) that store data and/or computer code for facilitating the various processes described herein. That is, in operation and use, the memory 147 stores at least portions of instructions and data for execution by the processor 146 to control the processing circuit 145. The memory 147 may be or include tangible, non-transient volatile memory and/or non-volatile memory. The processor 146 may be implemented as one or more processors, application specific integrated circuits (ASIC), one or more field programmable gate arrays (FPGAs), a digital signal processor (DSP), a group of processing components, or other suitable electronic processing components. The processing circuit 145 may include one or more processors that are configured to communicate such that the processing circuit 145 may perform or assist in performing any of the operations, steps, or methods discussed herein.

### Gas Pump Transactions Involving Coins and Vouchers

Referring now to FIG. 2, with additional reference to FIG. 1, a process 200 for operating an automated gasoline pump attachment for coin counting and voucher dispensing is shown, according to one embodiment. In a step 201, a gas pump transaction is initiated. The transaction can be initiated with either of the coin/voucher assembly 100 or the gasoline pump assembly 140. For example, a user may approach a gas pump and press an initiation key on the display device 113 on the coin/voucher assembly 110 or the display device 143. The user may touch an initiation key on the gasoline pump attachment within one or more of the input/output circuit 112 or the input/output circuit 142. In the step 201, the user may be invited, via one or more of the display devices 113 or 143, to deposit a number of coins into a coin hopper (e.g., the coin receiver 118). In a step 202, coins are received. For example, a user may pour a number of coins of different denominations into the coin receiver 118. In a step 203, a currency total of the received coins via the coin receiver 118 is determined based on the value of the coins received in the step 202. For example, the coin receiver 118 may be configured to receive the coins, convert the coins into a currency total, and deposit the coins in a deposit box located within the gasoline pump (e.g., the gasoline pump assembly 140). It should be noted, however, that the user may proceed through the aforementioned steps without depositing any coins. As the various steps below make clear, the coin/voucher assembly 110 and the gasoline pump assembly 140 may also be configured to accept a voucher or other form of payment.

In a step 204, a determination is made as to whether to accept an additional card or voucher-based currency. For example, the display device 113 may provide the user with one or more user interfaces inquiring as to whether the user would like to proceed with pumping gas based on the currency total associated with the deposited coins, or wait to pump gas until additional currency is provided via a debit card, credit card, or voucher. After the step 204, the process 200 may split into two branches. One branch may proceed with a step 205 and the other step may proceed with a step 214. The process 200 may proceed with the step 205 where an indication is received that no additional card/voucher-based currency will be provided. The process 200 may proceed with the step 214 where an indication is received that an additional card/voucher-based currency will be provided. Such indications as to whether to proceed with the step 205 or the step 214 may be received via one or more user interfaces provided by the display device 113.

In the step 205, the user provides an indication that no additional card or voucher-based currency will be provided. For example, the user may respond to one or more user interfaces with a selection that no additional card or voucher-based currency will be provided. In other words, the user may provide an indication that the user intends to proceed with pumping gas based on the coin currency total determined in the step 203 alone, if any. Thus, in a step 206, the user may pump gas (via the gasoline dispenser 148) based on the currency total from the received coins. For example, the user may handle a gas pump nozzle connected to the gasoline dispenser 148, insert the gas pump nozzle into a receptacle of a vehicle of the user, and pump gas. In some embodiments, the currency total of the received coins is displayed on one or both of the display device 113 or the display device 143. As the user pumps gas, the shown balance may decrease as the user pumps gas. In a step 207, a determination is made as to whether there is a balance of remaining currency after gas has been pumped. For example, the user may remove the gas pump nozzle from the vehicle before all of the currency total of the received coins has been applied to the gas pump transaction. Accordingly, the shown balance via the display device 113 or the display device 143 may stop decreasing and display a remaining currency balance. In this case, the user would have a remaining balance of currency. As another example, the user may pump gas until the entire currency total of the received coins has been expended. In this case, the shown balance via the display device 113 and/or the display device 143 would reach a balance of zero and the gas pump nozzle would stop pumping gas in the receptacle of the vehicle. Thus, the user would not have a remaining balance of currency. After the step 207, the process 200 may split into another two branches. One branch may proceed with a step 208 and another branch may proceed with a step 212. The process 200 may proceed with the step 208 where it is determined that there is a remaining balance of currency. The process 200 may proceed with the step 212 where it is determined that there is no remaining balance of currency. Here, the user may have previously indicated that no additional card or voucher-based currency would be provided, and all of the currency total of the received coins would have been expended. Where the process 200 proceeds with the step 212, the gas pump transaction is then completed in a step 224. At the step 224, the user may be given the option of receiving a receipt from the transaction and the user may optionally receive a receipt associated with the transaction via the gasoline pump assembly 140.

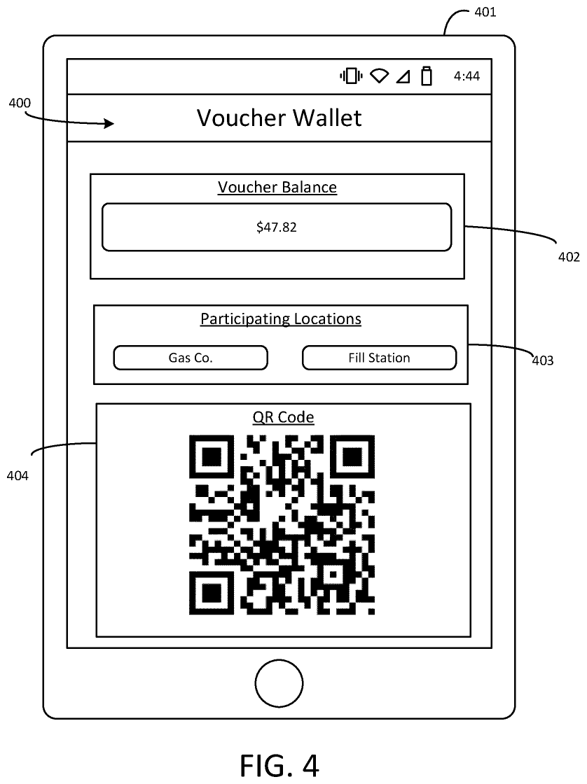

In some embodiments, a step 209 occurs after the step 208. In the step 209, the remaining currency is applied to a voucher. Here, the user may have removed the gas pump nozzle from the vehicle, thus terminating the pump process, before the entire currency total of received coins had been expended. Thus, the user is provided with one or more display interfaces to determine how to allocate the remaining balance of currency to a new or existing voucher. In a step 210, a determination is made as to whether the user holds an existing voucher. For example, the user may have operated one such coin/voucher assembly 110 in the past and currently hold a voucher (whether a physical card voucher or a voucher registered to a voucher wallet on the customer mobile device 150 via the voucher management computing system 130) with an existing balance, as described in further detail herein. The voucher may be associated with an identifier, and the user can input the identifier into one or more of the coin/voucher assembly 100, the gasoline pump assembly, 140 or the customer mobile device 150. After the step 210, the process 200 may split into another two branches. One branch may proceed with a step 211 and another branch may proceed with a step 213. The process 200 may proceed with the step 211 where a determination is made that the user does not hold an existing voucher. For example, the user may select an option via the display device 113 that the user does not hold an existing voucher. In this case, the user may need to be provided with a voucher to retain the remaining balance of currency on a new voucher. Accordingly, in the step 211, a new voucher is provided with a total of the remaining currency and the gas pump transaction is completed in the step 224. The new voucher may be provided via the voucher dispenser device 119. In some embodiments, the voucher dispenser device 119 prints a physical voucher with a scan-able bar code, a QR code, or magnetic strip, or an RFID chip, or another form of physical readable and writeable media. The physical voucher would be provided with the scan-able bar code, QR code, magnetic strip, or RFID chip to associate the physical voucher with a balance that may be used in future transactions, as described in further detail below. In some embodiments, the new voucher is associated with a new identifier. The new identifier can be provided to the customer mobile device 150 and the voucher management computing system 130. In other embodiments, and as described in further detail below in regards to FIG. 4, the user may be prompted to create a voucher wallet (e.g., download the voucher management application 122 to the customer mobile device 150) to store the total of the remaining currency on the voucher wallet or store the voucher in a pre-existing digital wallet such as a wallet from a third party. In some arrangements, the user may create a voucher account via the voucher management application 122 and scan a barcode or QR code displayed on the voucher management application 122 via the input/output circuit 112 to store the total of the remaining currency on the voucher wallet. In other arrangements, the user may bring the customer mobile device 150 into contact with the input/output circuit 112 to transfer information associated with the total of the remaining currency to the voucher wallet via RFID or NFD information transfer.

The process 200 may proceed with the step 213 where a determination is made that the user does hold an existing voucher. In the step 213, the remaining currency is applied to a pre-existing balance on the existing voucher and the gas pump transaction is completed in the step 224. For example, the user may hold an existing voucher card. The user may be prompted, via the display device 113, to scan the physical voucher via the input/output circuit 112. In some embodiments, where the user maintains a digital voucher in a voucher wallet on the customer mobile device 150 via the voucher management computing system 130, the user may input account information regarding the voucher wallet via the user interface device 110 (e.g., input a phone number associated with an existing account, an account number, a username and password, etc.) and/or scan an image, such as a QR code, associated with the voucher wallet via the input/output circuit 112. In some embodiments, identification of the voucher wallet on the customer mobile device 150 may include inputting account information via the display device 113, receiving a one-time-passcode transmitted from the coin/voucher assembly 110 to the customer mobile device 150, and inputting the one-time passcode to via the display device 113. In any case, the remaining currency would be applied to the balance associated with the user's physical voucher or voucher wallet.

In some embodiments, and recalling the determination made at the step 204, the process 200 may proceed with the step 214 where an indication is received that an additional card/voucher-based currency will be provided. Following the step 214, the user pumps gas based on the currency from the received coins in a step 215. Following the step 215, a determination is made as to whether to accept a balance on a pre-existing voucher in a step 216. Following the step 216, the process 200 may split into another two branches. One branch may proceed with a step 217 and another branch may proceed with a step 219. The process 200 may proceed with the step 217 where an indication is received that a pre-existing voucher will be provided. The process 200 may proceed with the step 219 where an indication is received that a pre-existing voucher will not be provided.

In some embodiments, in the step 217, an indication is received that a pre-existing voucher will be provided. Following the step 217, additional gas is pumped based on a balance on a pre-existing voucher in a step 218. As suggested above, a user may present a pre-existing physical voucher to be scanned by the voucher scanner 109 or present the customer mobile device 150 with an existing voucher wallet application. Presenting a pre-existing voucher may occur in the form of scanning a barcode (displayed by either the physical voucher or the customer mobile device 150), a QR code, swiping a magnetic strip, entering a phone number (or an email address, pin, or other identifying information associated with the voucher wallet application) on the user interface device 141 of the gasoline pump assembly 140 to provide an identifier associated with the customer and the pre-existing voucher. The entered information can be correlated with information stored in the customer voucher database 135, for example, to confirm the customer information is accurate and/or a balance is present associated with the customer information. In any case, the user may proceed with pumping gas based on a balance on the physical voucher card or a balance on the user's voucher wallet confirmed by the voucher management computing system 130. Following the step 218, the process 200 joins the two branches that split after the step 216 at a step 220.

In some embodiments, in the step 219, an indication is received that a pre-existing voucher will not be provided. Following the step 219, the process 200 joins the two branches that split after the step 216 at the step 220.

In some embodiments, at the step 220, a determination is made as to whether a credit or debit card will be accepted. Following the step 220, the process 200 may split into another two branches. One branch may proceed with a step 221 and another branch may proceed with a step 222. The process 200 may proceed with the step 221 where an indication is received that a no credit or debit card will be provided and the gas pump transaction is then completed at the step 224. The process 200 may proceed with the step 222 where an indication is received that a credit or debit card will be provided. Following the step 222, the user may pump additional gas based on a credit or balance on the credit or debit card via the input/output circuit 142 in a step 223. In this case, the user may present a standard credit or debit card to continue a conventional gas pump transaction. Following the step 223, the gas pump transaction is completed with the step 224.

### User Interface for Gas Pump Transactions Involving Coins and Voucher

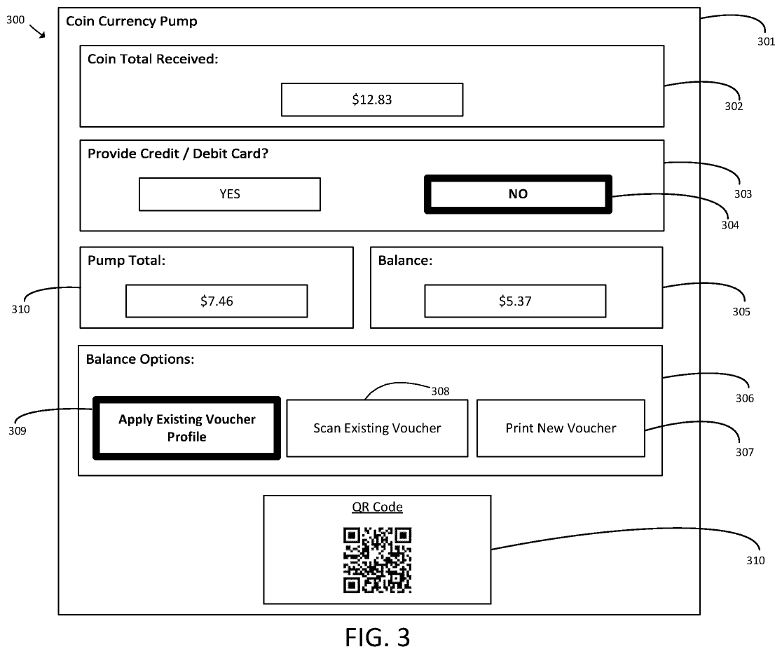

Referring to FIG. 3, with additional reference to FIGS. 1 and 2, a schematic diagram of the one or more user interfaces 300 presented by the display device 113 is shown, according to some embodiments. The interfaces 300 may include a home screen 301 indicating that the display device 113 is presenting information relating to pumping gasoline based on coin currency. The home screen 301 may include a number of menus. As shown, the home screen 301 includes a total currency indication 302, an additional currency selection 303, a pump total indication 310, a balance indication 305, and a balance option selection 306. The total currency indication 302 may represent the currency total from the received coins. For example, this value may be displayed in step 203. The additional currency selection 303 may provide a user with an a yes/no option to provide a voucher, debit, or credit card to pump additional gas beyond that which may be pumped based on the currency total from the received coins. For example, the additional currency selection 303 may be prompted to the user at the step 204. As shown, the user may make a selection 304 that no additional voucher, debit, or credit card will be provided. As such, the process 200 depicted in FIG. 2 would proceed from step 204 to step 214, rather than step 205. In a case where the user makes the selection 304 to rather indicate that additional currency would be provided, the display device 113 may provide additional user interfaces to facilitate such operations as described in the process 200 resulting from proceeding with step 214.

In some embodiments, after the user has finished pumping fuel, the display device 113 may present the user with the pump total indication 310 and the balance indication 305. As shown, the pump total indication 310 may notify the user of the cost of the fuel pumped. The balance indication 305 may notify the user of the balance indication 305 where the value displayed in the pump total indication 310 is less than the value displayed in the total currency indication 302. For example, the value displayed by the balance indication 305 may be the difference between the value displayed in the total currency indication 302 and the value displayed in the pump total indication 310. For example, the existence of a positive value displayed by the balance indication 305 may illustrate the step 207 above. As suggested in the step 208, where a balance of remaining currency exists, various options relating to vouchers may be considered by the user. As shown, and as described in greater detail above in regards to the steps 210, 211, and 213, the balance option selection 306 may provide the user with a selection between a selection 309, a selection 308, and a selection 307. The selection 309 may allow the user to apply the balance to an existing voucher profile. For example, and as described in greater detail below in regards to FIG. 4, the user may present the voucher management application 122 via the customer mobile device 150. Alternatively, the selection 308 may allow the user to scan an existing physical voucher to store the balance and the selection 307 may allow the user to elect to have a physical voucher printed with the remaining balance stored on the new physical voucher. The new physical voucher may be presented to the user via the voucher dispenser device 119.

In some embodiments, the interface 300 further includes a QR code 310 for identifying the coin/voucher assembly 110 via the customer mobile device 150 to perform the systems and methods described herein.

### Voucher Wallet

Referring to FIG. 4, an example screenshot of a voucher wallet 401 is illustrated, according to one embodiment. The voucher wallet 401 may perform various functions in accordance with the function of the voucher management application 122 of the customer mobile device 150. The voucher wallet 401 may include a voucher balance indicator 402, a participating locations menu 403, and a QR code 404. The voucher balance indicator 402 may indicate the amount of currency stored to the voucher mobile wallet. For example, after each gas pump transaction where the user applies a remaining balance of coin currency to the voucher wallet 401 (e.g., via the step 213 above), the voucher balance indicator 402 would display a greater value. If on the other hand, the voucher wallet 401 is used to pump gas via the stored balance (e.g., via the step 218 above), the voucher balance indicator 402 would display a lesser value.

In some embodiments, the participating locations menu 403 is presented to the user with one or more user interfaces directing the user to one or more fuel pump locations that offer a gas pump attachment for coin counting and voucher dispensing. As shown, two participating locations are shown on the participating locations menu 403. In some embodiments, the user may select one of the locations from the participating locations menu 403 and be presented with one or more user interfaces providing a location and/or directions to reach the particular location of the associated fuel pump location.

In some embodiments, the QR code 404 is used to apply the balance indicated via the voucher balance indicator 402 on gas pump transactions. For example, as described in the step 218 above, the user may scan the QR code 404 via a scanner on the input/output circuit 112 to apply the balance indicated via the balance indicator 402 to pump gas. In other embodiments, the QR code 404 may be used to apply a balance of coin currency from the gas pump transaction to the user's voucher wallet 401 (e.g., as described in the step 213 above).

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

Using the above described service vehicles and methods, a user may, at least in part, complete a gas pump transaction and, in some embodiments, receive a voucher for later payments storing a balance of the currency of coins not applied to the current gas pump transaction.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the electromechanical variable transmission as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system comprising:
a gasoline pumping assembly comprising a gasoline dispenser configured to perform a fueling process for a fueling process cost;
a voucher assembly communicably coupled to the gasoline pumping assembly, the voucher assembly comprising;
a coin receiver configured to receive a plurality of coins of a total value from a user; and
a voucher dispenser configured to provide to the user a remaining balance via a voucher when the total value is greater than the fueling process cost,
wherein the remaining balance is a difference between the total value and the fueling process cost.

2. The system of claim 1, further comprising:
a user device communicably coupled to the voucher assembly, the user device comprising a processing circuit configured to:
receive the voucher from the voucher dispenser;
store the voucher in a wallet on the user device; and
when the total value is less than the fueling process cost, provide the voucher to the voucher assembly.

3. The system of claim 1, wherein at least one of the voucher assembly or the gasoline pumping assembly further comprises a user interface configured to receive a user input, the system further comprising:
a database communicably coupled to the user interface, the database comprising a plurality of customer identifiers; and
a processing circuit communicably coupled to the database and the user interface, the processing circuit comprising one or more processors configured to determine if the user input correlates with at least one of the plurality of customer identifiers,
wherein if the user input does not correlate with the at least one of the plurality of customer identifiers, the voucher dispenser provides to the user the remaining balance via a voucher by generating a new voucher with a new customer identifier.

4. The system of claim 3, wherein if the user input does correlate with the at least one of the plurality of customer identifiers the voucher dispenser provides to the user the remaining balance via a voucher by applying the remaining balance to a pre-existing voucher associated with the at least one of the plurality of customer identifiers.

5. The system of claim 1, wherein the voucher is a digital voucher to be received by a user device communicably coupled with the voucher dispenser.

6. The system of claim 1, wherein the fueling process is a first fueling process and the fueling process cost is a first fueling process cost, wherein at least one of the voucher assembly or the gasoline pumping assembly comprise a payment receiver configured to receive a second payment from the user, and wherein when the total value is equal to the first fueling process cost, the gasoline pumping assembly initiates a second fueling process based on receipt of the second payment.

7. The system of claim 6, wherein the payment receiver comprises a voucher receiver configured to receive a pre-existing voucher, and wherein the second payment is a pre-existing balance associated with the pre-existing voucher.

8. The system of claim 7, wherein the payment receiver is configured to receive a third payment from the user via a credit or debit card, and wherein the gasoline pumping assembly initiates a third fueling process based on receipt of the third payment.

9. The system of claim 7, wherein the pre-existing voucher is a digital voucher stored on a user device.

10. The system of claim 6, wherein the payment receiver is a credit card scanner.

11. A method for pumping gasoline, the method comprising:
receiving, via a coin receiver, a plurality of coins from a user;
determining a total value for the plurality of coins;
initiating a fueling process from a pumping assembly;
terminating the fueling process;
determining whether a fueling process cost associated with the fueling process is less than the total value; and
in response to a determination that the total value is greater than the fueling process cost providing, via the pumping assembly, a remaining balance on a voucher to the user, wherein the remaining balance is a difference between the total value and the fueling process cost.

12. The method of claim 11, further comprising:
receiving, via a user device communicably coupled to the pumping assembly, the voucher;
storing, on the user device, the voucher;
providing, in response to a determination that the fueling process cost will exceed the total value, the voucher to the pumping assembly; and
initiating a second fueling process based at least in part on the receipt of the voucher.

13. The method of claim 12, further comprising:
providing, from the user device, the voucher to a point of sale affiliated with an operator of the pumping assembly.

14. The method of claim 11, further comprising:
receiving, user interface, a user input comprising a customer identifier;
determining whether the customer identifier corresponds to at least one of a plurality of customer identifiers in a database; and
in response to a determination that the customer identifier does not correspond to at least one of the plurality of customer identifiers, providing the remaining balance to the user via a new voucher associated with a new customer identifier.

15. The method of claim 14, further comprising, in response to a determination that the customer identifier does correspond to at least one of the plurality of customer identifiers, providing the remaining balance to the user via a voucher by applying the remaining balance to a pre-existing voucher associated with the at least one of the plurality of customer identifiers.

16. The method of claim 11, wherein the voucher is a digital voucher, the method further comprising receiving, on a user device, the digital voucher.

17. The method of claim 11, wherein the fueling process is a first fueling process, and wherein the first fueling process is terminated when the fueling process cost equals the total value, the method further comprising:
receiving a second payment; and
initiating a second fueling process based on the second payment.

18. The method of claim 17, wherein the second payment is a pre-existing voucher with a pre-existing balance.

19. The method of claim 18, further comprising:
terminating the second fueling process with a second fueling process cost associated equals the pre-existing balance;
receiving a third payment via a credit or debit card; and
initiating a third fueling process based on the third payment.

20. An system comprising:
a gasoline dispenser configured to perform a fueling process for a fueling process cost;
a voucher assembly communicably coupled to the gasoline dispenser, the voucher assembly comprising;
a coin receiver configured to receive a plurality of coins from a user;
a voucher dispenser configured to provide to the user a voucher; and
a voucher receiver configured to receive a pre-existing voucher from the user;
a database communicably coupled to the voucher assembly comprising a plurality of customer identifiers; and
a processing circuit communicably coupled to the voucher assembly and the gasoline dispenser, the processing circuit comprising one or more memory devices coupled to one or more processors, the one or more memory devices configured to store instructions thereon that, when executed by the one or more processors, cause the one or more processors to:
determine a total value for the plurality of coins;
initiate a first fueling process for a first fueling process cost;
in response to a determination that the first fueling process cost is less than the total value, provide a remaining balance to a user via a new voucher; and
in response to receiving the pre-existing voucher via the voucher receiver from the user, initiating a second fueling process.
